(19) United States
(12) Patent Application Publication
(10) Pub. No.: US 2007/0133043 A1
(43) Pub. Date: Jun. 14, 2007

(54) Image log function display program, image log function display method, image processing apparatus, and image processing system

(75) Inventors: Takao Maekawa, Kanagawa (JP); Tetsuo Suzuki, Kanagawa (JP); Masahiro Machida, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/476,684

(22) Filed: Jun. 29, 2006

(30) Foreign Application Priority Data
Dec. 13, 2005 (JP) 2005-359206

(51) Int. Cl. G06F 3/12

(52) U.S. Cl. 358/1.15; 358/400

(57) ABSTRACT

A computer readable medium storing a program causing a computer to execute a function for displaying information on an image log, the function includes: generating an image log from an image which is used in processing a job, the job performed by an image processing apparatus; transferring the generated image log to a device that is connected to the image processing apparatus; generating information which includes status of at least one of the generating the image log or the transferring the image log; and displaying the generated information.

This application claims priority under 35 USC 119 from Japanese patent document, JP2005-359206, the disclosure of which is incorporated by reference herein.

### BACKGROUND

1. Technical Field

The present invention relates to an image log function display program, an image log function display method, an image processing apparatus, and an image processing system having a function of generating image logs from images that have been handled by a job in job log management which manages job logs (i.e., a job execution record) of copy jobs, print jobs, scanning jobs, facsimile jobs, etc. after they were carried out.

2 Related Art

Printing systems are commonly known in which plural clients and a printer are connected to a LAN (local area network) and plural users can share the printer.

In the above printing systems, a client generates print data of a document to be printed and the document can be printed by transmitting the print data to the printer which is shared via the network. When printing has been performed by the printer, a job log of the print job is stored in the printer. For example, a job log consists of a job ID, a job type, a job reception time, a job end time, a job status, etc.

However, in the conventional printing systems, since the printer is usually installed at a place that is distant from the clients, printed sheets may be stolen by a third person if they are left as they are. In the case of a secret document, some measure should be taken to prevent leakage of secret information. However, it is difficult to prevent leakage of secret information by managing only job logs, because in that case a leakage source cannot be determined when leakage of a secret document has occurred.

One method for strengthening the log management to prevent leakage of secret information is to generate image logs from images handled by a job and transfer the generated image logs to a management server in such a manner that they are correlated with a job log. However, since the generation and transfer of image logs take time, a long time elapses from the start to the end of a job and a job end time cannot be predicted, which lowers the ease of use of the printing system.

### SUMMARY

According to an aspect of the invention, a computer readable medium storing a program causing a computer to execute a function for displaying information on an image log, the function includes: generating an image log from an image which is used in processing a job, the job performed by an image processing apparatus; transferring the generated image log to a device that is connected to the image processing apparatus; generating information which includes status of at least one of the generating the image log or the transferring the image log; and displaying the generated information.

### BRIEF DESCRIPTION OF THE DRAWINGS

Exemplary embodiments of the present invention will be described in detail based on the following figures, wherein:

FIG. 1 shows the configuration of an image processing system according to a first exemplary embodiment of the present invention.

FIG. 2 is a block diagram of each multifunction machine according to the first exemplary embodiment of the invention.

FIG. 3 is a block diagram of a job log management server according to the first exemplary embodiment of the invention.

FIG. 4 shows a currently-reading-document picture which is displayed in each multifunction machine according to the first exemplary embodiment of the invention.

FIG. 5 shows a currently-generating-image-log picture which is displayed in each multifunction machine according to the first exemplary embodiment of the invention.

FIG. 6 shows a currently-transferring-image-log picture which is displayed in each multifunction machine according to the first exemplary embodiment of the invention.

FIG. 7 shows a currently-printing picture which is displayed in each multifunction machine according to the first exemplary embodiment of the invention.

FIG. 8 is a flowchart showing an ordinary-mode process of each multifunction machine according to the first exemplary embodiment of the invention.

FIG. 9 shows a currently-generating-image-log picture which is displayed in each multifunction machine according to a second exemplary embodiment of the invention.

FIG. 10 shows a currently-transferring-image-log picture which is displayed in each multifunction machine according to the second exemplary embodiment of the invention.

FIG. 11 is a flowchart showing an ordinary-mode process of each multifunction machine according to the second exemplary embodiment of the invention.

FIG. 12 shows a service details setting picture which is displayed in each multifunction machine according to a third exemplary embodiment of the invention during execution of a copy job in the case where the image log function is off and a setting is made that image log generation/non-generation information should not be displayed.

FIG. 13 shows a currently-generating-image-log picture which is displayed in each multifunction machine according to a fourth exemplary embodiment of the invention.

FIG. 14 shows a currently-transferring-image-log picture which is displayed in each multifunction machine according to the fourth exemplary embodiment of the invention.

FIGS. 15A to 15D show transitions between job status pictures which are displayed in each multifunction machine according to a fifth exemplary embodiment of the invention.

### DETAILED DESCRIPTION

### FIRST EXEMPLARY EMBODIMENT

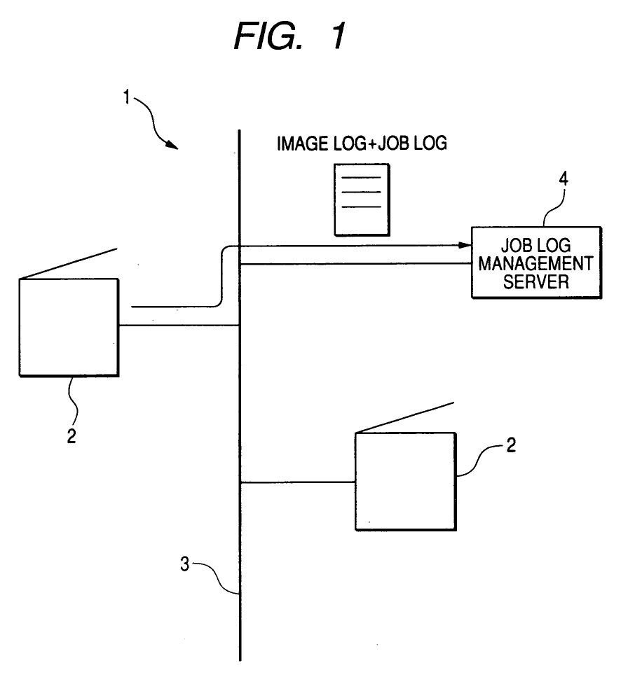

FIG. 1 shows an image processing system according to a first exemplary embodiment of the present invention. The image processing system 1 is provided with multiple multifunction machines 2 that are image processing apparatuses and a job log management server 4. Each multifunction machine 2 carries out a job, generates its job log, generates image logs from images handled by the job, and displays an image log generation status or transfer status. The job log management server 4 stores job logs and image logs that are transferred from the multifunction machines 2 via a network 3.

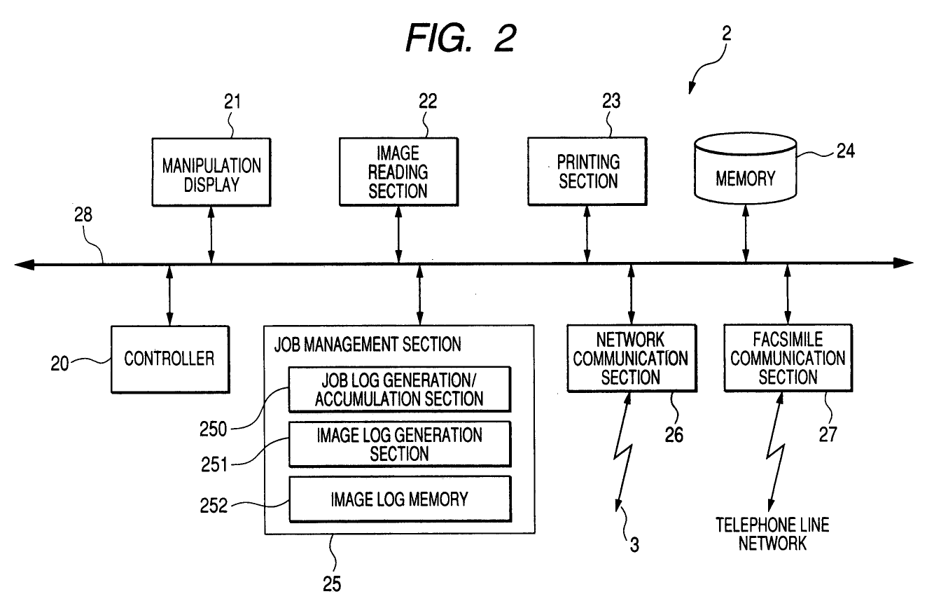

FIG. 2 is a block diagram of each multifunction machine 2. The multifunction machine 2 is provided with a CPU, a ROM, a RAM, etc. and is equipped with a controller 20 and controls the individual sections of the multifunction machine 2; a manipulation display 21 that is provided with hard keys such as a start key and a touch panel display in which a touch panel is mounted on the surface of a display; an image reading section 22 that reads the image of a document sheet optically; a printing section 23 that prints an image on a sheet by electrophotography or the like, a memory 24 such as an HDD that stores various kinds of information such as setting pictures, setting information, and images; a job management section 25 that receives a job, issues a job ID, and generates a job log etc. after execution of the job; a network communication section 26 that is connected to the network 3, and a facsimile communication section 27 that is connected to a telephone network or the like. The sections 21-27 are connected to each other via a bus 28.

The multifunction machine 2 has multiple functions corresponding to respective services such as copying, printing, scanning, facsimile, and e-mail. A job processes an image using one or more of these functions. In this exemplary embodiment, a job is received by the manipulation display 21. However, a job may be received via a user terminal (not shown) such as a personal computer (PC) which is connected to the network 3.

Various programs such as job execution programs, a job log management program, an image log generation status and transfer status display program are stored in the ROM of the controller 20 and the memory 24. The CPU of the controller 20 controls the individual sections of the multifunction machine 2 according to the programs stored in the ROM and the memory 24.

The job management section 25 is equipped with a job log generation/accumulation section 250 that generates a job log after execution of a job and stores it; an image log generation section 251 that generates image logs from images handled by a job; and an image log memory 252 that stores image logs in such a manner that they are correlated with a job log. The job management section 25 operates under the control of the CPU of the controller 20.

For example, a job log consists of a multifunction machine ID, a job ID, a job type, a user name, a job reception time, a job end time, status information such as job standby, job under processing, job stop, job completion, the number of output sheets, and an error type, and other information.

The image log generation section 251 generates an image log by processing an image handled by a job according to an image log generation method that is stored in the memory 24. Examples of the image log generation method include lowering the resolution of an image and selecting a page to be employed as an image log.

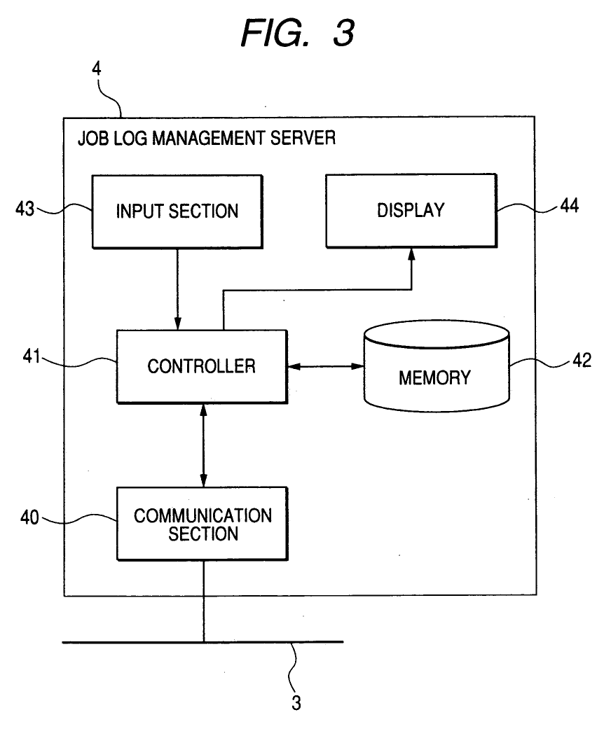

FIG. 3 is a block diagram of the job log management server 4. The job log management server 4 has a communication section 40 which is connected to the network 3, a controller 41 equipped with a CPU, a ROM, a RAM, etc. and controls the individual sections of the server 4, a memory 42 such as an HDD, an input section 43 that is equipped with a keyboard, a mouse, etc., and a display 44 such as an LCD that displays a setting picture etc.

Various programs are stored in the ROM of the controller 41 and the memory 42, and the CPU of the controller 41 controls the individual sections of the job log management server 4 according to the programs stored in the ROM and the memory 42.

The memory 42 stores image logs, job logs, and setting pictures etc. that are transferred from the multifunction machines 2. Image logs are stored so as to be correlated with a job log by using a multifunction machine ID and a job ID, for example.

### Operation of First Exemplary Embodiment

Next, the operation of this exemplary embodiment will be described for individual cases.

(1) Manager Setting Mode

A manager of the system 1 or each multifunction machine 2 inputs a password by manipulating the manipulation display 21 of the multifunction machine 2. If the manager is authenticated, a manager setting mode is established. The manager selects an “image log function setting” button in a menu picture and thereby causes the manipulation display 21 to display an image log function setting picture.

The manager makes an image log function on/off setting in the image log function setting picture. When the image log function setting picture is closed, the setting made in the image log function setting picture becomes effective. The controller 20 stores the thus-determined image log function setting information in the memory 24.

If a “close” button is depressed after selecting “image log function on,” the controller 20 causes the manipulation display 21 to display an image log generation setting picture. If the manager sets each of an image log generation method and image log transfer timing by selecting from multiple items in the image log generation setting picture, the controller 20 stores those pieces of setting information in the memory 24 and makes a transition from the manager setting mode to an ordinary mode. Examples of the image log transfer timing are when the multifunction machine 2 is powered on, at the end of a job, at night, and during a power saving mode when the temperature of the printing section 23 is low.

(2) Ordinary Mode

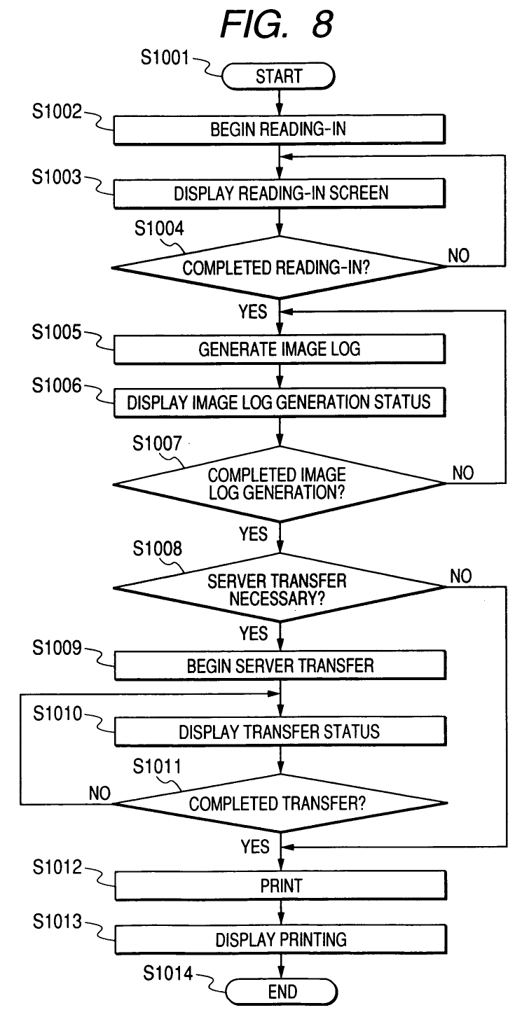

FIG. 8 is a flowchart showing an ordinary-mode process of each multifunction machine 2. In an initial state, the controller 20 of the multifunction machine 2 causes the manipulation display 21 to display a menu picture. If a user selects a service in the menu picture, the controller 20 causes the manipulation display 21 to display a service details setting picture corresponding to the selected service. The user sets service details by manipulating the manipulation display 21 of the multifunction machine 2. FIG. 8 corresponds to an exemplary case when copying has been selected as a service. When the user depresses a start button, a copy job is started at step S1001.

Then, at step S1002, the controller 20 causes the image reading section 22 to read the image of a document sheet by scanning it. The image reading section 22 stores the read-out document image in the memory 24. At step S1003, the controller 20 causes the manipulation display 21 to display a currently-reading-document picture as a currently-executing-job picture. In this exemplary embodiment, a log generation status or transfer status is displayed in the currently-executing-job picture.

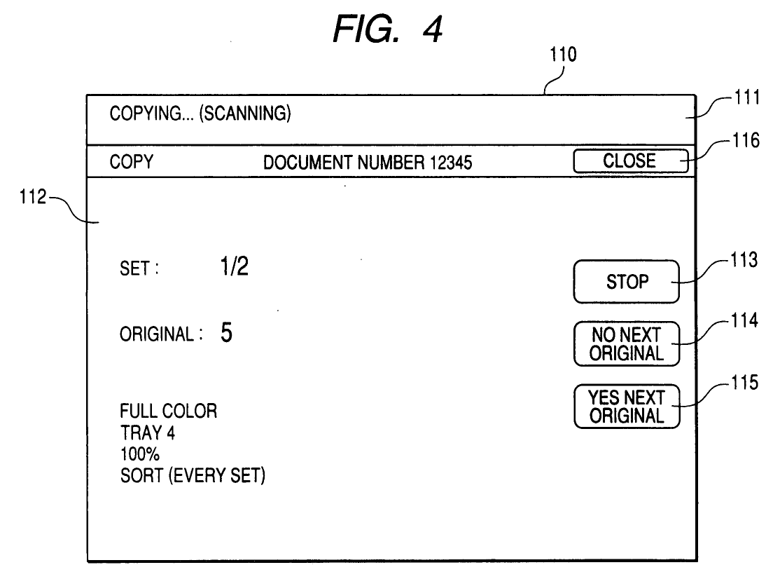

FIG. 4 shows an example of the currently-reading-document picture. This picture 110 includes a service status display area 111, a service status details display area 112, a “stop” button 113, a “next document page absent” button 114, a “next document page present” button 115, and a “close” button 116. Copy job progress information is displayed in the service status display area 111.

When all pages of the document have been read out (step S1004: yes), the controller 20 starts image log generation at step S1005. Under the control of the controller 20, the image log generation section 251 of the job management section 25 generates an image log by subjecting a document image handled by the job to image processing. The image processing conforms to the image log generation method stored in the memory 24. If a large number of document pages need to be read out, generation of image logs of already read-out document images may be started during reading of the current document. Generated image logs are stored in the image log memory 252 together with a multifunction machine ID and a job ID. At step S1006, the controller 20 causes the manipulation display 21 to display a currently-generating-image-log picture.

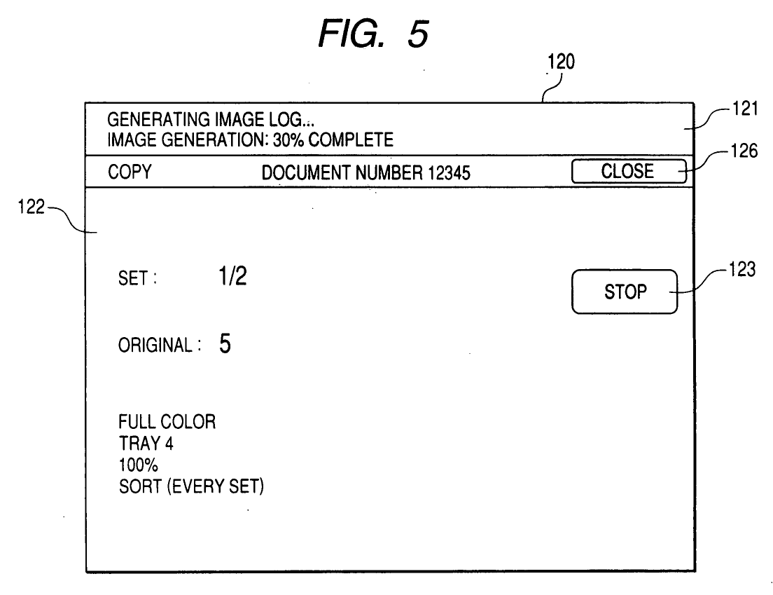

FIG. 5 shows an example of the currently-generating-image-log picture. The picture 120 includes a service status display area 121, a service status details display area 122, a “stop” button 123, and a “close” button 126. Image log generation status information is displayed in the service status display area 121. This display allows a user to know that image logs are being generated as well as the progress of the image log generation. The image log generation rate is displayed as a percentage.

For example, if the image log generation status is displayed in terms of the number of image-log-generated pages when only the first three pages are generated, a malicious user can recognize an intended number of image log generation pages. Then, the malicious user may copy three different unnecessary, pages. Thus, a conduct of the malicious user may be prevented by displaying the image log generation status as a percentage, as described above.

If all image logs have been generated (step S1007: yes) and if server transfer is necessary (step S1008: yes), at step S1009 a transfer of the image logs to the job log management server 4 is started according to the image log transfer timing that is stored in the memory 24. That is, the job management section 25 transfers a job log and the image logs to the job log management server 4 via the network communication section 26 and the network 3. The controller 41 of the job log management server 4 receives, via the communication section 40, the job log and the image logs transferred from the multifunction machine 2, and stores the job log and the image logs in the memory 42 in such a manner that they are correlated with each other. At step S1010, the controller 20 causes the manipulation display 21 to display a currently-transferring-image-log picture.

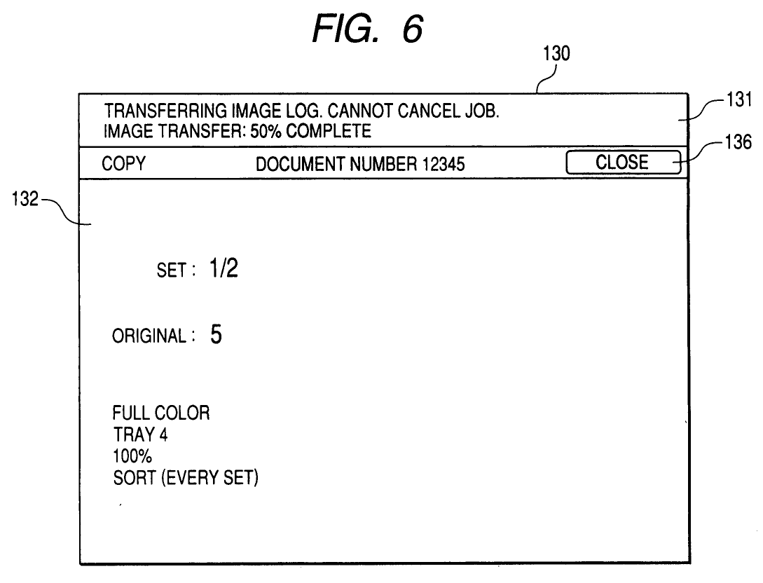

FIG. 6 shows an example of the currently-transferring-image-log picture. The picture 130 includes a service status display area 131, a service status details display area 132, and a “close” button 136. Image log transfer status information and information to the effect that the job cannot be cancelled are displayed in the service status display area 131. This display allows a user to know that image logs are being transferred as well as the progress of the transfer. The image log transfer rate is displayed in percentage. Each multifunction machine 2 is configured so that a job cannot be cancelled halfway.

When all image logs have been transferred (step S1001: yes), printing is performed at step S1012. That is, the controller 20 reads document image data from the memory 24 and sends the data to the printing section 23. The printing section 23 prints document images on sheets and outputs the sheets. At step S1013, the controller 20 causes the manipulation display 21 to display a currently-printing picture.

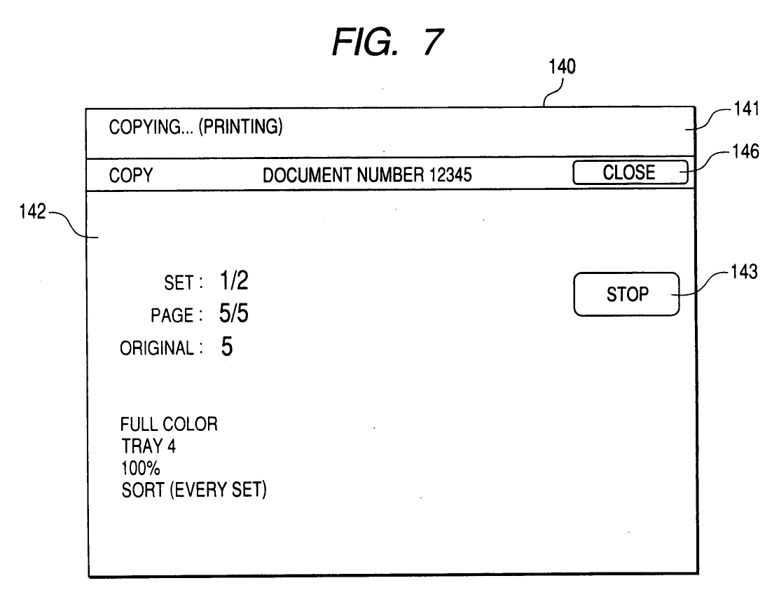

FIG. 7 shows an example of the currently printing picture. The picture 140 includes a service status display area 141, a service status details display area 142, a “stop” button 143, and a “close” button 146. Copy job progress status information is displayed in the service status display area 141. This display allows a user to know the fact that printing is being performed. At step S1014, the process is finished when all images have been printed.

### SECOND EXEMPLARY EMBODIMENT

Next, an image processing system according to a second exemplary embodiment of the invention will be described. The second exemplary embodiment is the same as the first exemplary embodiment in the diagram showing the configuration of the system 1 and the block diagrams of each multifunction machine 2 and the job log management server 4, and hence those drawings corresponding to the second exemplary embodiment are omitted.

Each multifunction machine 2 according to the second exemplary embodiment is configured in the same manner as that according to the first exemplary embodiment except that a log generation or transfer status is displayed in a certain area on the LCD (liquid crystal display) separately from a currently-executing-job picture after service details have been set and a start button has been depressed; that a currently-generating-image-log picture is displayed while the detailed service settings remain displayed; and that a currently-transferring-image-log picture is displayed while the detailed service settings remain displayed. The job log management server 4 of this exemplary embodiment is configured in the same manner as that of the first exemplary embodiment.

### Operation of Second Exemplary Embodiment

Next, the operation of this exemplary embodiment will be described for individual cases.

(1) Manager Setting Mode

In this exemplary embodiment, settings of each multifunction machine 2 are made by a manager in the same manner as in the first exemplary embodiment.

(2) Ordinary Mode

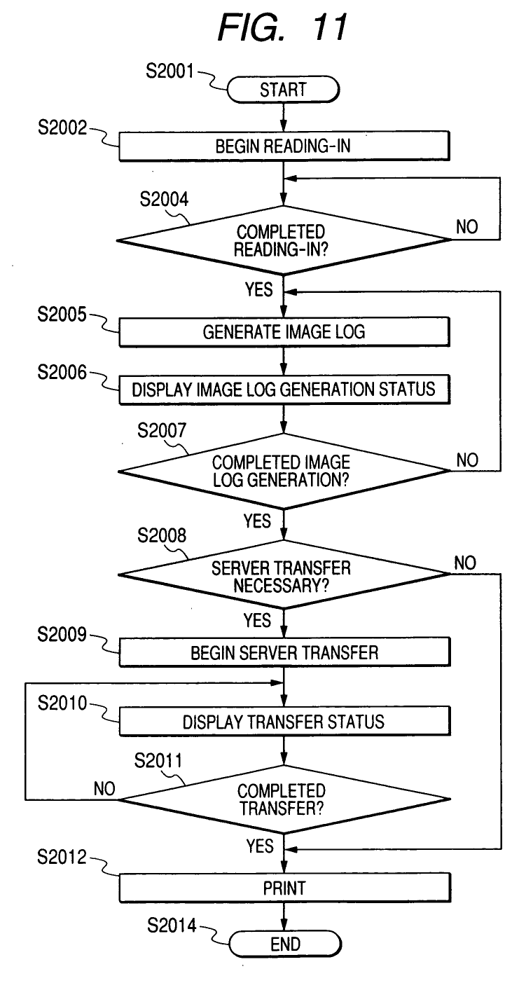

FIG. 11 is a flowchart showing an ordinary-mode process of each multifunction machine 2 in the second exemplary embodiment. In an initial state, the controller 20 of the multifunction machine 2 causes the manipulation display 21 to display a menu picture. If a user selects a service in the menu picture, the controller 20 causes the manipulation display 21 to display a service details setting picture. The user sets service details in the service details setting picture. FIG. 11 corresponds to an exemplary case when copying is selected as a service. When the user depresses a start button, a copy job is started at step S2001. At step S2002, a document sheet is read by scanning.

When all pages of the document have been read out (step S2004: yes), the controller 20 starts image log generation at step S2005 as in the first exemplary embodiment. At step S2006, the controller 20 causes the manipulation display 21 to display a currently-generating-image-log picture.

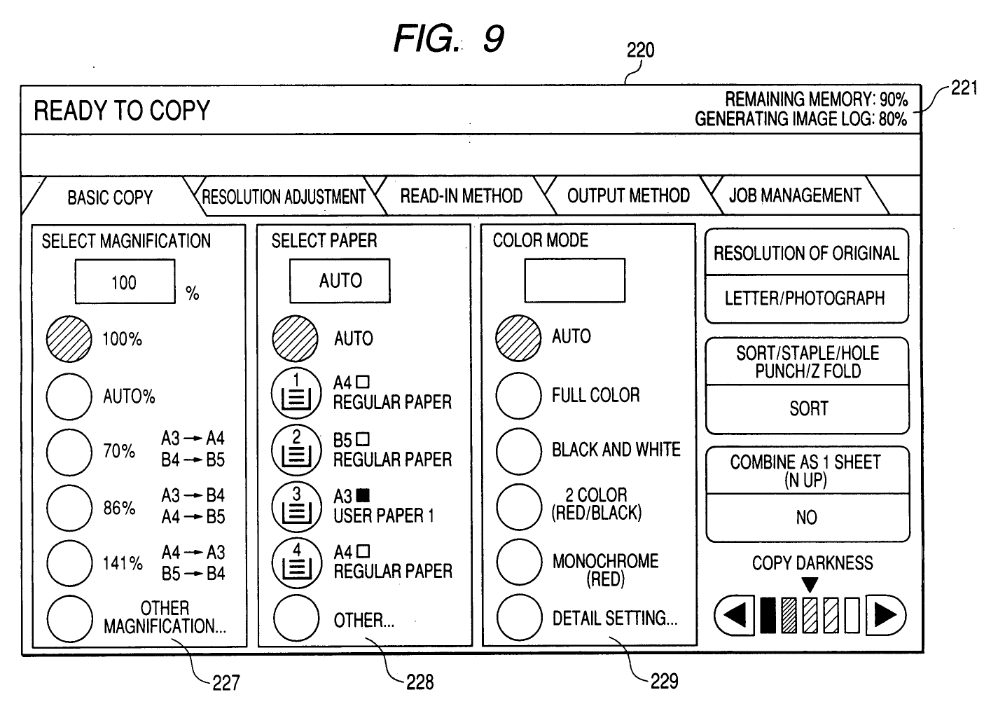

FIG. 9 shows an example of the currently-generating-image-log picture. The picture 220 includes a service status display area 221, magnification selection buttons 227, sheet selection buttons 228, and color buttons 229. Residual memory capacity information, a job reception status (not shown), and image log generation status information are displayed in the service status display area 221. A log generation or transfer status is displayed in a certain area on the LCD (liquid crystal display) separately from the currently-executing-job picture. This display allows a user to know the fact that image logs are being generated as well as the progress of the image log generation. The image log generation rate is displayed as a percentage.

If all image logs have been generated (step S2007: yes) and if server transfer is necessary (step S2008: yes), at step S2009 a transfer of the image logs to the job log management server 4 is started in the same manner as in the first exemplary embodiment. Naturally, a transfer need not always be started after generation of all image logs, and image logs of pages may be transferred sequentially in order of generation. At step S2010, the controller 20 causes the manipulation display 21 to display a currently-transferring-image-log picture.

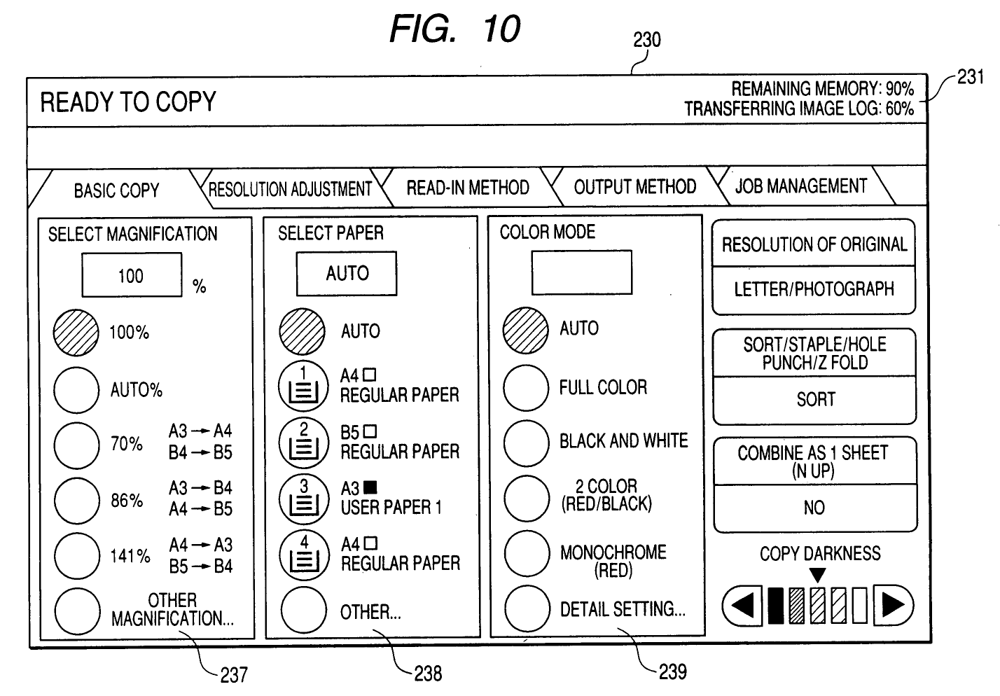

FIG. 10 shows an example of the currently-transferring-image-log picture. The picture 230 includes a service status display area 231, magnification selection buttons 237, sheet selection buttons 238, and color buttons 239. Residual memory capacity information, a job reception status (not shown), and image log transfer status information are displayed in the service status display area 231. This display allows a user to know the fact that image logs are being transferred as well as the progress of the transfer. The image log transfer rate is displayed as a percentage.

When all image logs have been transferred (step S2011: yes), printing is performed at step S2012 as in the first exemplary embodiment. The above-described process makes it possible to determine a leakage source on the basis of the image logs and the job log when a document leakage has occurred. At step S2014, the process is finished when all images have been printed.

### THIRD EXEMPLARY EMBODIMENT

Next, an image processing system according to a third exemplary embodiment of the invention will be described. The third exemplary embodiment is the same as the first and second exemplary embodiments in the diagram showing the configuration of the system 1 and the block diagrams of each multifunction machine 2 and the job log management server 4, and hence those drawings corresponding to the third exemplary embodiment are omitted.

An image log security level is set in each multifunction machine 2 according to this exemplary embodiment. The image log security level includes to what extent a user should be informed of occurrence/non-occurrence, the degree of progress, a progress status, etc. of image log generation or transfer. If the image log security level is high, the degree of disclosure of the details of image log processing to a user is low. Almost no information on the image log processing is given to the user and hence the security level is high. An image log security level is stored in the ROM of the controller 20 or the memory 24. A display item setting step of setting a display item to be displayed as the progress status may be included. The display item setting step may set a display item to be displayed as the progress status in accordance with the image log security level. For example, the progress status may be displayed in percentage to prevent a user from predicting such information as an effective number of image log generation pages in the case where the image log security level is high, and it may be displayed in the number of pages in the case where the image log security level is low. This further increases the security against a malicious user. In the other points, each multifunction machine 2 is configured in the same manner as in the second exemplary embodiment. The job log management server 4 of this exemplary embodiment is configured in the same manner as that of the first exemplary embodiment.

### Operation of Third Exemplary Embodiment

Next, the operation of this exemplary embodiment will be described for individual cases.

(1) Manager Setting Mode

A manager of the system 1 or each multifunction machine 2 inputs a password by manipulating the manipulation display 21 of the multifunction machine 2. If the manager is authenticated, a manager setting mode is established. The manager selects an “image log function setting” button in a menu picture and this causes the manipulation display 21 to display an image log function setting picture. The manager selects an image log function on/off setting in the image log function setting picture. When the image log function setting picture is closed, the setting made in the image log function setting picture becomes effective. The controller 20 stores the thus-determined image log function setting information in the memory 24.

After the image log function setting picture is closed, the controller 20 causes the manipulation display 21 to display an image log security level setting picture.

The manager selects an image log security level high/low setting in the image log security level setting picture. When the image log security level setting picture is closed, the setting made in the image log security level setting picture becomes effective. The controller 20 stores the thus-determined image log security level setting information in the stored device 24.

After the image log security level setting picture is closed, the controller 20 causes the manipulation display 21 to display an image log generation status and transfer status display setting picture.

The manager selects from image log generation status and transfer status display items in the image log generation status and transfer status display setting picture. In this exemplary embodiment, selection is made from display items of “number-of-pages display,” “percentage display,” “number-of-bytes display,” and “no display.” An alternative procedure is possible wherein a display item is selected automatically in accordance with the setting made in the image log security level setting picture and the manager confirms the automatic selection. There may also be a display item option that “currently generating” or “currently transferring” should be displayed but detailed information such as the number of pages should not be displayed.

If “image log function off” was selected in the image log function setting picture, a setting as to whether to display information to the effect that image logs are not generated can be made in the image log generation status and transfer status display setting picture. For example, in machines in arcade markets such as those inconvenience stores, a setting that causes an UI to display that image logs are not generated may be enabled. This allows users to use machines with comfort.

When the image log generation status and transfer status display setting picture is closed, the setting made in the image log generation status and transfer status display setting picture becomes effective. The controller 20 stores the thus-determined image log generation status and transfer status display setting information in the memory 24.

In this exemplary embodiment, after the image log generation status and transfer status display setting information is determined and stored, a transition is made from the manager setting mode to an ordinary mode. An alternative procedure is possible wherein after an image log security level is input, an image log generation status and transfer status display setting is made automatically in accordance with the image log security level, the image log security level is determined and stored, and finally a transition is made from the manager setting mode to the ordinary mode.

(2) Ordinary Mode

In an initial state, the controller 20 of the multifunction machine 2 causes the manipulation display 21 to display a menu picture. If a user selects a service in the menu picture, the controller 20 causes the manipulation display 21 to display a service details setting picture. The user sets service details in the service details setting picture. When the user depresses a start button, a copy job, for example, is started. Then, a document sheet is read by scanning it.

If the image log function is on, generation of image logs is started when all document pages have been read out. Then, a currently-generating-image-log picture is displayed on the manipulation display 21. If all image logs have been generated and if server transfer is necessary, a transfer of the image logs to the job log management server 4 is started. Subsequently, a currently-transferring-image-log picture is displayed on the manipulation display 21. If all the image logs have been transferred, printing is performed. The process is finished when all images have been printed. The above-described process makes it possible to determine a leakage source on the basis of the image logs and the job log when a document leakage has occurred.

If the image log function is off, image logs are not generated even when all document pages have been read out. If a setting is set so a message that image logs are not generated should not be displayed, the service details setting picture is kept displayed until the end of the printing.

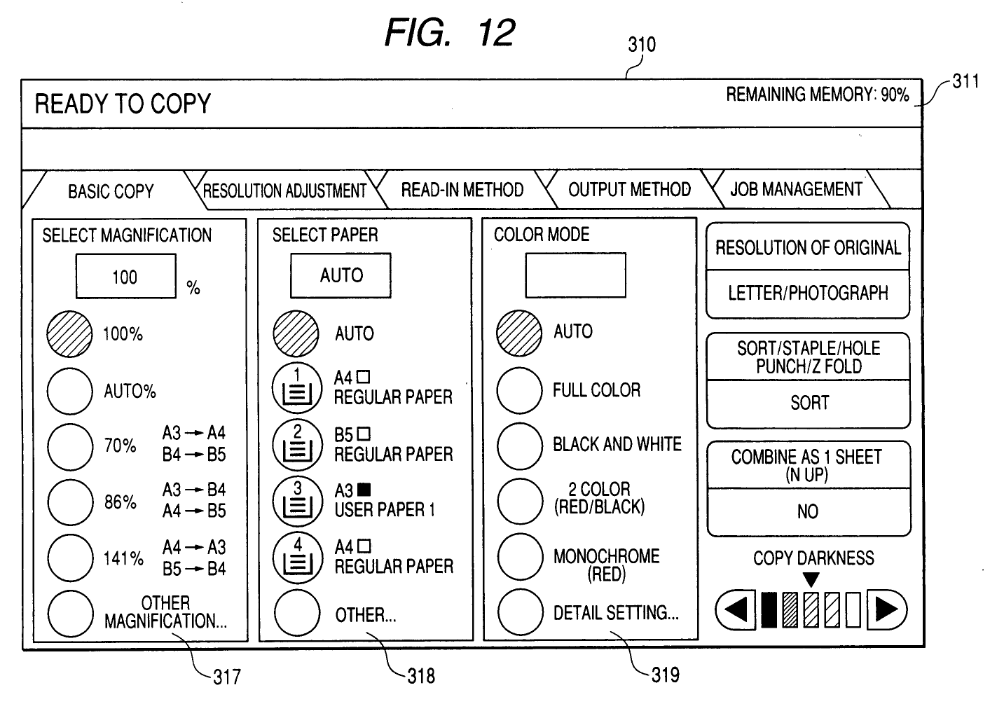

FIG. 12 shows a service details setting picture which is displayed in each multifunction machine during execution of a copy job in the case where the image log function is off and a setting is made that image log generation/non-generation information should not be displayed. The picture 310 includes a service status display area 311, magnification selection buttons 317, sheet selection buttons 318, and color buttons 319. Residual memory capacity information and a job reception status are displayed in the service status display area 311. A message that image logs are not generated is not displayed.

Where image logs are generated, the job management section 25 issues a multifunction machine ID and a job ID upon the start of a job and manages the job on the basis of the multifunction machine ID and the job ID. The job log generation/accumulation section 250 of the job management section 25 generates and stores a job log after execution of the job. The image log generation section 251 generates an image log by subjecting an image handled by the job to image processing that conforms to the image log generation setting information stored in the memory 24. Instructions as to job settings and job execution may be input through a user terminal that is connected to the network 3. Since an image handled by the job is stored after being reduced (lowered in resolution), a large-capacity memory is not necessary.

Then, in the job management section 25, image logs generated by the image log generation section 251 are stored in the image log memory 252 so as to be correlated with the corresponding job log. The controller 20 transfers the job log and the image logs to the job log management server 4 via the network communication section 26 and the network 3 with prescribed timing such as when the multifunction machine 2 is powered on or at the end of the job. The controller 41 of the job log management server 4 receives, via the communication section 40, the job log and the image logs transferred from the multifunction machine 2 and stores the job log and the image logs in the memory 42 in such a manner that they are correlated with each other. The job log and the image logs are subjected to job management of the manager.

### FOURTH EXEMPLARY EMBODIMENT

Next, an image processing system according to a fourth exemplary embodiment of the invention will be described. The fourth exemplary embodiment is the same as the first exemplary embodiment in the diagram showing the configuration of the system 1 and the block diagrams of each multifunction machine 2 and the job log management server 4, and hence those drawings corresponding to the fourth exemplary embodiment are omitted.

Each multifunction machine 2 according to this exemplary embodiment is configured in the same manner as that according to the first exemplary embodiment except that an image log generation status and transfer status are displayed in terms of the number of pages. The job log management server 4 of this exemplary embodiment is configured in the same manner as that of the first exemplary embodiment.

### Operation of Fourth Exemplary Embodiment

Settings of each multifunction machine 2 are made by a manager in the same manner as in the first exemplary embodiment. In this exemplary embodiment, an image log is generated for every page. An image log generation status or transfer status (image log generation status and transfer status display item) is displayed in terms of the number of pages instead of a percentage. In the other aspects, the operation of the fourth exemplary embodiment is the same as that of the first exemplary embodiment. The currently-reading-document picture and the currently-printing picture are the same as in the first exemplary embodiment.

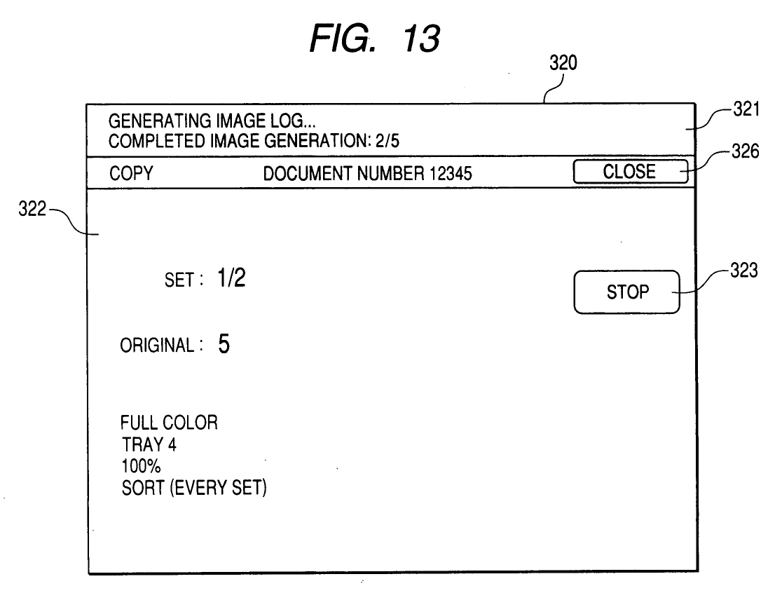

FIG. 13 shows a currently-generating-image-log picture which is displayed in each multifunction machine 2. The picture 320 includes a service status display area 321, a service status details display area 322, a “stop button” 323, and a “close” button 326. Image log generation status information is displayed in the service status display area 321. That is, an image log generation status is displayed in terms of the number of pages, and more specifically, as a fraction in which the denominator is the number of document pages and the numerator is the number of image-log-generated pages. This display allows a user to know the fact that image logs are being generated and to know, in the form of the number of pages, the progress of the image log generation.

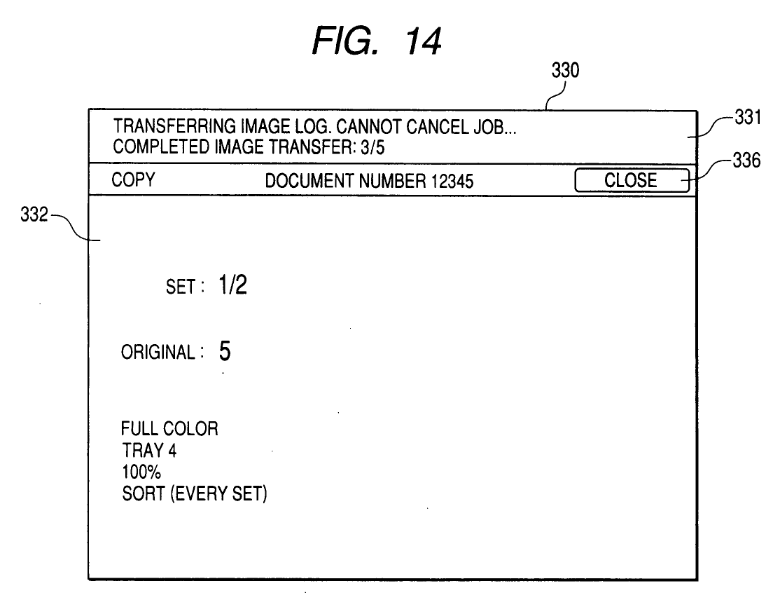

FIG. 14 shows a currently-transferring-image-log picture which is displayed in each multifunction machine 2. The picture 330 includes a service status display area 331, a service status details display area 332, and a “close” button 336. Information to the effect that the job cannot be canceled and image log transfer status information are displayed in the service status display area 331. An image log transfer status is displayed in terms of the number of pages, more specifically, as a fraction in which the denominator is the number of document pages and the numerator is the number of image-log-transferred pages. This display allows a user to know the fact that image logs are being transferred and to know, in the form of the number of pages, the progress of the image log transfer.

### FIFTH EXEMPLARY EMBODIMENT

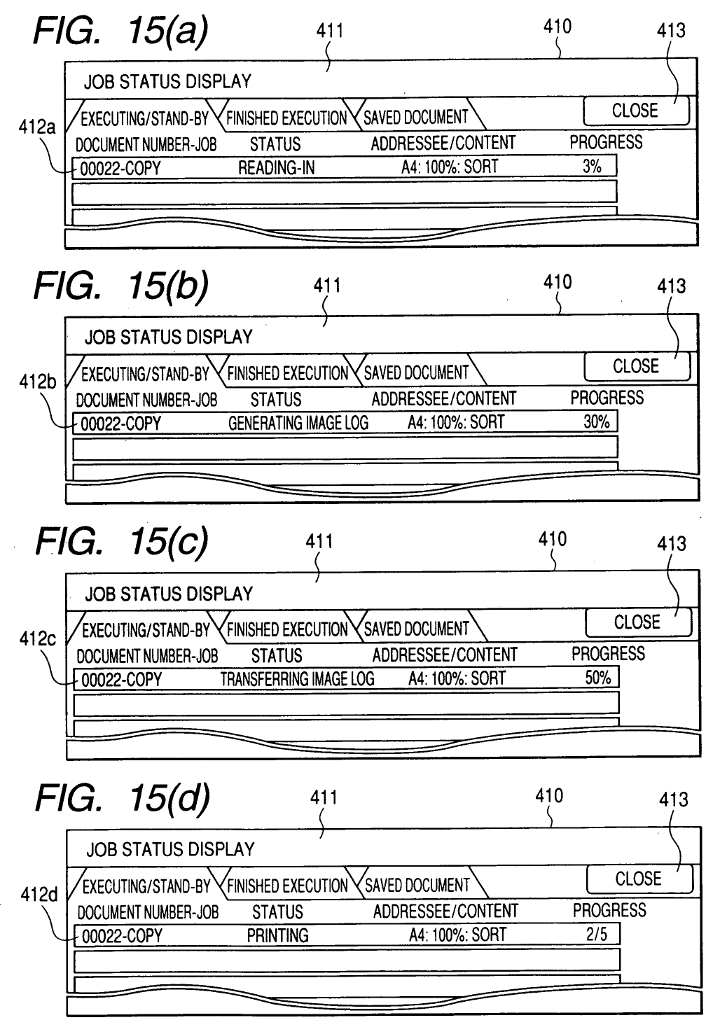

FIGS. 15A to 15D show job status pictures showing an image log generation status or transfer status which is displayed in each multifunction machine according to a fifth exemplary embodiment of the invention. FIG. 15A shows a job status picture 410 which is displayed during document reading, FIG. 15B shows a job status picture 410 which is displayed during image log generation, FIG. 15C shows a job status picture 410 which is displayed during an image log transfer, and FIG. 15D shows a job status picture 410 which is displayed during printing. Each job status picture 410 includes a service status display area 411, a service status details display area 412a, 412b, 412c, or 412d, and a “close” button 413.

A job type, a service status, service details, and a progress status are displayed in each of the service status details display areas 412a-412d. Where the image log function is on, job information that is not usually displayed is displayed at all times.

According to the fifth exemplary embodiment, since a user can always recognize a progress status, prevention of document leakage, prediction of a job end time, and prevention of an erroneous operation are enabled at all times.

### OTHER EXEMPLARY EMBODIMENTS

The invention is not limited to the above exemplary embodiments, and various modifications are possible without departing from the spirit and scope of the invention. Further, components of the exemplary embodiments can be combined in a desired manner without departing from the spirit and scope of the invention.

The image log function display program may further include a display item setting step of setting a display item to be displayed as the progress status. Examples of the display item are a generation status or transfer status expressed in the number of pages or the number of bytes, a generation rate or a transfer rate expressed in percentage, and a display of “under generation” or “under transfer.”

For example, although in the above exemplary embodiments printing is performed after a transfer of image logs, where image logs are transferred after printing a currently-transferring-image-log picture maybe kept displayed until completion of a transfer of image logs. Where a setting is made that image logs are transferred after completion of desired document image output, the next specification setting cannot be started because a job exists even if an IIT or an IOT is not in operation. Even in such a case, displaying an image log transfer status allows a user to predict when specification setting will be enabled.

An image log generation or transfer end time or a remaining time required may be provided as image log generation status and transfer status display items. This allows a user to know an end time correctly.

A user may be notified of an image log generation status or transfer status by flashing or turning-on an LED(s). This makes it possible to cause a user to pay attention to the manipulation display 21 of the multifunction machine 2.

A user may also be notified of an image log generation status or transfer status by a voice. This allows a user to recognize a job progress status even if he or she is not looking at the manipulation display 21 of the multifunction machine 2.

A user may also be notified of an image log generation status or transfer status by, for example, an attention light which indicates the state of a machine using the color of the light. This allows a user to recognize a job progress status even in the case of use in a noisy factory or the like.

Not only an image log generation status or transfer status but also an explanation of the image log function maybe displayed during image log generation or transfer. This makes it possible to enlighten a user about the security and the image log function.

On the other hand, to prevent a user from predicting the number of document pages for which image logs should be generated, a setting may be made so that even an image log generation rate will not be displayed even if the image log function is on.

Each multifunction machine 2 may be configured so that a currently-executing-job picture of a job for which image logs are being generated or transferred cannot be closed when the image log function is on.

Each multifunction machine 2 may be configured so that a job cannot be stopped while image logs are being generated or transferred. This prevents a malicious user from stopping a job.

The image log generation section 251 may generate image logs on the basis of data obtained by the image reading section 22's optically reading an instruction sheet on which job details and image log generation conditions are written.

Although in the above exemplary embodiments a job log and image logs are stored in the management server 4, they may be stored in the multifunction machine 2 or an external memory instead of the management server 4. A job log and image logs may be stored in different devices.

A thumbnail image may be generated which consists of multiple image logs. This allows a user to quickly recognize image contents of respective image logs.

Although in the above exemplary embodiments pictures are displayed on the manipulation display 21, they may be displayed on, for example, the display of a user terminal.

Examples of the display of a progress status, an image log generation status, or an image log transfer status are display using light, characters, or the like and audible indicators using a buzzer sound, a voice, or the like. Visible display and audible indication may be performed simultaneously.

The term “job” includes a job flow for performing a series of processing on images. In the case of a job flow, since multiple processings are sequentially performed on a common image, an image log is generated for the common image. The term “image handled by a job” includes an image being processed in the job and an image obtained at the end of the job. An exemplary method for storing image logs in such a manner that they are correlated with a job log is that each image log is stored so as to be correlated with a job ID, an ID that is assigned to the document image uniquely, and an ID of the apparatus that generates the job logs.

The term “external apparatus” includes a management server that manages one or more image processing apparatus and an external memory.

The term “image processing apparatus” includes machines having a single function such as a copier, a printer, a scanner, and a facsimile machine, a multifunction machine having plural functions such as copying, printing, scanning, and facsimile, and a system as a combination from a copier, a printer, a scanner, a facsimile machine, etc.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a function for displaying information on an image log, the function comprising:
generating an image log from an image which is used in processing a job, the job performed by an image processing apparatus;
transferring the generated image log to a device that is connected to the image processing apparatus;
generating information which includes status of at least one of the generating the image log or the transferring the image log; and
displaying the generated information.

2. The computer readable medium according to claim 1, the function further comprising:
setting whether or not to display the generated information.

3. The computer readable medium according to claim 1, the function further comprising:
setting a display item to be displayed as the status.

4. The computer readable medium according to claim 3, wherein:
the display item includes a security level of the image log which is generated or transferred.

5. The computer readable medium according to claim 4, wherein:
the display item to be displayed is set in accordance with the security level of the image log.

6. A method for displaying an image log function display, the method comprising:
generating an image log from an image which is used in processing a job, the job performed by an image processing apparatus;
transferring the generated image log to a device that is connected to the image processing apparatus;
generating information which includes status of at least one of the generating the image log or the transferring the image log; and
displaying the generated information.

7. The method according to claim 6, further comprising: setting whether or not to display the generated information.

8. The method according to claim 6, further comprising:
setting a display item to be displayed as the status.

9. The method according to claim 8, wherein:
the display item includes a security level of the image log which is generated or transferred.

10. The method according to claim 9, wherein:
the display item to be displayed is set in accordance with the security level of the image log.

11. An image processing apparatus comprising:
a job execution unit that executes a job;
a job log generating unit that generates a job log about the execution of the job;
an image log generating unit that generates an image log from an image handled by the job;
a transfer unit that transfers the job log and the image log to an external apparatus; and
a display that displays an information on status of at least one of the generation of the image log and the transfer of the image log.

12. An image processing system which includes an image processing apparatus that carries out a job and a management server connected to the image processing apparatus via a network, the system comprising:
a job execution unit that executes a job;
a job log generating unit that generates a job log about the execution of the job;
an image log generating unit that generates an image log from an image handled by the job;
a transfer unit that transfers the generated job log and the generated image log to an external apparatus;
a display that displays an information on status of at least one of the generation of the image log and the transfer of the image log; and
a memory that stores the job log and the image log transferred from the transfer unit so that the job log and the image log are correlated with each other.
